(19) United States
(12) Patent Application Publication
(10) Pub. No.: US 2007/0272096 A1
(43) Pub. Date: Nov. 29, 2007

(54) MOLD FOR SWEETS WITH AN IMPRINT

(75) Inventor: Rene Sophia Jozef Reijnen, Susteren (NL)

Correspondence Address: FOLEY & LARDNER LLP, 777 EAST WISCONSIN AVENUE, MILWAUKEE, WI, 53202-5306, US

(73) Assignee: CFS Weert B.V.

(21) Appl. No.: 11/749,520

(22) Filed: May 16, 2007

(30) Foreign Application Priority Data
May 17, 2006 (EP) EP 06 010 175.5

(51) Int. Cl. B44B 5/00

(52) U.S. Cl. 101/3.1

(57) ABSTRACT

A machine is provided for the production of sweets that are molded into a certain form and furnished with an imprint. The machine includes a mold with an exchangeable embossed stamp on which a negative of the imprint is provided.

### CROSS-REFERENCE TO RELATED PATENT APPLICATIONS

European Priority Application No. EP 06 010 175.5, filed May 17, 2006, including the specification, drawings, claims, and abstract, is incorporated herein by reference in its entirety.

### BACKGROUND

The present invention relates to a machine for the production of sweets that are molded into a certain form and furnished with an imprint. More specifically, the invention relates to a machine having a mold with an exchangeable embossed stamp, on which the negative for the imprint is provided.

Sweets, preferably lollipops, are merchandised nowadays in a special form and additionally with a certain imprint. Often, the lot size of these sweets is rather small, so that the price per sweet is relatively high.

It is therefore one objective to provide a machine for the production of sweets that allows the reduction of production costs for sweets with a low lot size.

### SUMMARY

One embodiment relates to a machine for the production of sweets that are molded into a certain form and furnished with an imprint, whereas the machine includes a mold with an exchangeable embossed stamp on which the negative of the imprint is provided.

It was totally surprising to a person skilled in the art, and could not have been expected, that with the inventive machine, the production cost per sweet, for example, a lollipop comprising an imprint, can be reduced significantly, especially for small lot sizes. The embossed stamp may be interchanged easily, which saves set-up time. Further, the inventive machine is manufactured and operated easily.

### BRIEF DESCRIPTION

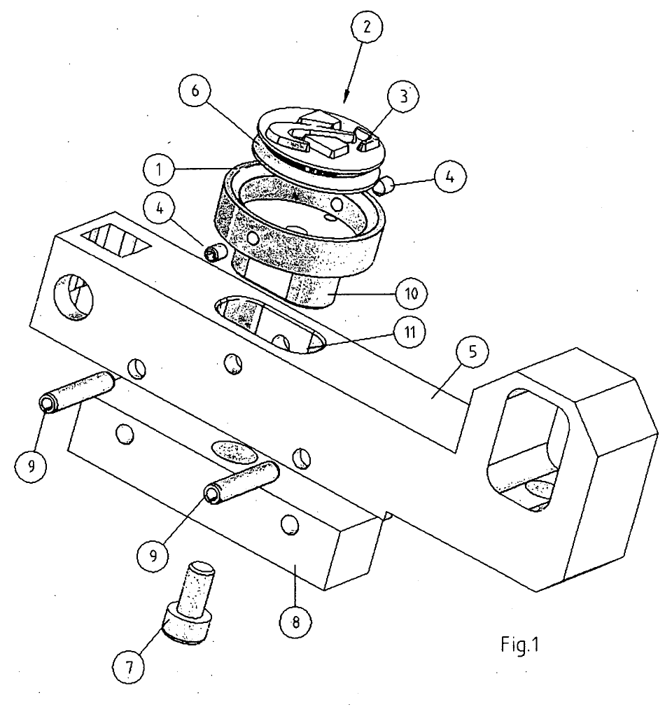

FIG. 1 is an illustration of a portion of a machine for the production of sweets according to an exemplary embodiment.

### DETAILED DESCRIPTION

Sweets may be produced, for example, by cutting a certain amount of sweets material from a string and forming it into a desired form, (e.g., a disk, a square, a ball, an oval, etc.). According to one embodiment, the sweets also include an imprint which can be a certain character, an alphabetic character, and/or a word, etc. The imprint may be imprinted into the sweets material while it is formed (e.g., before the sugar in the sweet, especially lollipop is hardened).

According to one embodiment to the present invention, the machine for the production of sweets comprises a mold having the form into which the sweets are molded. Furthermore, the inventive machine comprises an exchangeable embossed stamp which comprises the negative of the imprint. Since the embossed stamp is exchangeable, the inventive machine can be re-tooled easily and cost-efficiently after a certain lot of sweets has been produced.

According to a preferred embodiment, the embossed stamp is inserted into the mold. The embossed stamp may be reversibly fastened at the mold, so that the embossed stamp is interchangeable. According to a particularly preferred embodiment, the embossed stamp comprises a groove into which a screw (e.g., a set screw, etc.) or the like is inserted to fasten the embossed stamp to the mold. A person skilled in the art will understand that other fastening means are also feasible.

According to various alternative embodiments, the embossed stamp may be made out of any material that can be exposed to food known to a person skilled in the art. However, in a preferred embodiment, the embossed stamp may be made of a plastic material. Plastic material can typically be processed easily and is able to withstand the elevated temperatures of the sweets material during forming. Furthermore, plastic material is often more resistant against abrasion than other materials.

According to a preferred embodiment, the mold itself is made of metal, for example, a metal that can be brought into contact with food.

According to another preferred embodiment, the mold itself is reversibly fixable to (e.g., removeable from, exchangeable, etc.) a holder. This has the advantage that the entire mold itself is also easily exchangeable so that the machine can be re-tooled even more easily after a certain lot has been produced.

Conventionally a pair of molds, e.g., an upper-mold or upper portion and a lower-mold or lower portion (each e.g., being similar to mold 1 shown in FIG. 1), cooperate to form a sweet. The molds can be moved from an opened- into a closed-position. One or both molds can be furnished with an embossed stamp. Furthermore, the machine may comprise a plurality of pairs of molds, which are arranged for example on a drum or on an endless chain and rotate, respectively.

The invention is now explained in further detail according to FIG. 1. However, these explanations do not limit the scope of protection of the present invention.

FIG. 1 shows a holder 5 which is attached via bolts 9 to a block 8 which may be part of a chain or a drum and which moves during production. Additionally, holder 5 comprises a recess 11 into which a foot 10 of mold 1 can be inserted. According to one embodiment, indentation 11 and foot 10 are designed such that mold 1 is non-rotatable when foot 10 is received within indentation 11. Furthermore, indentation 11 may comprise holes which allow a fixation of foot 10, for example, via headless screws (not depicted).

Into the mold 1, a embossed stamp 2 may be inserted which comprises on its surface a negative 3 of an imprint configured to be pressed into the sweets material. Embossed stamp 2 may further comprise at its circumference a groove 6 which facilitates the fixation of embossed stamp 2 in mold 1 via headless screws 4.

After embossed stamp 2 has been inserted, sweets may be produced by inserting sweets material into embossed stamp 2 and compressing mold 1 with an additional mold (not depicted), which may be arranged on top of depicted mold 1. The two molds are brought together and separated again after the sweet has the desired shape, permitting removal of the sweet.

It is important to note that the preferred and other exemplary embodiments are illustrative only. Although only a few embodiments have been described in detail in this disclosure, those skilled in the art who review this disclosure will readily appreciate that many modifications are possible without materially departing from the novel teachings and advantages of the subject matter recited herein. Other substitutions, modifications, changes, and omissions may be made in the design, operating conditions, and arrangement of the preferred and other exemplary embodiments without departing from the scope of the present invention.

What is claimed is:

1. A machine for the production of sweets that are molded into a certain form and furnished with an imprint, comprising:
a mold with an exchangeable embossed stamp on which a negative of the imprint is provided.

2. The machine of claim 1, wherein the embossed stamp is configured to be inserted into the mold.

3. The machine of claim 1, wherein the embossed stamp is interchangeably fastened to the mold.

4. The machine of claim 3, wherein the embossed stamp comprises a groove into which a screw is inserted to fasten the embossed stamp to the mold.

5. The machine of claim 1, wherein the embossed stamp is made of a plastic material.

6. The machine of claim 1, wherein the mold is made of metal.

7. The machine of claim 1, further comprising:
a holder;
wherein the mold is reversibly fixable to the holder.

8. The machine of claim 1, wherein the mold comprises an upper portion and a lower portion that can be moved from an opened into a closed position.

9. The machine of claim 8, further comprising a plurality of molds arranged on a drum or an endless chain.
